(19) United States
(12) Patent Application Publication
(10) Pub. No.: US 2006/0253555 A1
(43) Pub. Date: Nov. 9, 2006

(54) Remote control apparatus

(76) Inventor: Kwok-Yan Leung, Willowdale (CA)

Correspondence Address: LIN & ASSOCIATES INTELLECTUAL PROPERTY, P.O. BOX 2339, SARATOGA, CA, 95070-0339, US

(21) Appl. No.: 11/121,720

(22) Filed: May 4, 2005

(51) Int. Cl. G06F 15/177

(52) U.S. Cl. 709/220

(57) ABSTRACT

A remote control apparatus is provided. The remote control apparatus enables a host computer (network administrator) to execute certain pre-boot services on each computer on a network. This remote control apparatus is configured with a primary connection module and a connection and service control module. The primary connection module is to use one MAC address selected from the MAC address table to directly connect to the associated computer, and then a virtual IP address is assigned for the computer. After the initial stage, the connection and service control module takes over the network connection using TCP/IP interface to allow packets to be routed to the virtual IP address of the computer, whereby certain pre-boot services such as network OS deployment, virus scanning, BIOS update, and system configuration and restoration can be performed in the pre-boot execution environment.

### BACKGROUND OF THE INVENTION

1. Field of the Invention

The present invention relates to a remote control apparatus, and in particular to a remote control apparatus that enables a host computer (network administrator) to execute certain pre-boot services on each network computer in the local area network environment.

2. The Related Art

Conventionally, to deploy certain network applications on network computers, the network administrator usually has to be there personally to install the network software on each network computer. But if this is a large network, the software deployment on all network nodes will be time-intensive for the network administrator.

To make the network more manageable, many types of distributed or remote control software are put out by the network vendors. Some of the software enable the network administrator to use a host computer to perform remote administrative services such as network OS deployment, virus scanning, and BIOS update on all network computers without having to visit the computer, and even to monitor the operation status on each network computer.

However, the currently available distributed software works on the condition that the OS of the computer has to be up and running, but in the case that the computer is not booted up. The above-mentioned pre-boot services are therefore not available to the computer.

To overcome the above-mentioned problems, the present invention intends to provide a remote control apparatus that enables the host computer to execute centrally administered services on each network computer while the computer is in the boot stage.

### SUMMARY OF THE INVENTION

The primary object of the present invention is to provide a remote control apparatus installable on a host computer that is able to directly connect to a network computer basing on the MAC address, and then to assign a virtual IP address to the computer for packets to be routed to the network computer through the Internet, whereby the network administrator is able to execute certain pre-boot services on each network computer in the local area network environment.

In accordance with the invention, the remote control apparatus is configured with a primary connection module and a connection and service control module. Each network computer shall be equipped with a disk controller unit, a packet processing unit, and a firewall unit.

In accordance with the invention, the basic functions of the disk controller unit include pre-formatting the hard disk on the computer, granting protection status to each system sector, and deploying network OS on the computer in the configuration mode.

In accordance with the invention, the basic functions of the firewall unit are authenticating the privilege level of the network computer trying to log in, scanning for viruses over incoming packets, and blocking unsafe packets from entering the computer.

In accordance with the invention, the basic functions of the packet processing unit include sending/receiving packets between computers in a network that supports TCP/IP protocols, and checking the integrity of each packet.

In accordance with the invention, the pre-boot execution is achieved in two stages. In the initial stage, the primary connection module of the remote control apparatus selects a MAC address from the existing MAC address table and establishes direction connection with the associated computer, and a virtual IP address is assigned for the computer. In the second stage, the connection and service control module of the remote control apparatus takes over the network connection using TCP/IP interface to allow packets to be routed to the virtual IP address.

The present invention enables the host computer to install, service, upgrade and troubleshoot network computers without visiting each machine in the pre-boot execution environment.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a block diagram of the configuration of the remote control apparatus and a network computer in accordance with the present invention; and

FIG. 2 shows the configuration of another embodiment of the invention with the addition of a firewall protection on the network computer.

### DETAILED DESCRIPTION OF THE PREFERRED EMBODIMENT

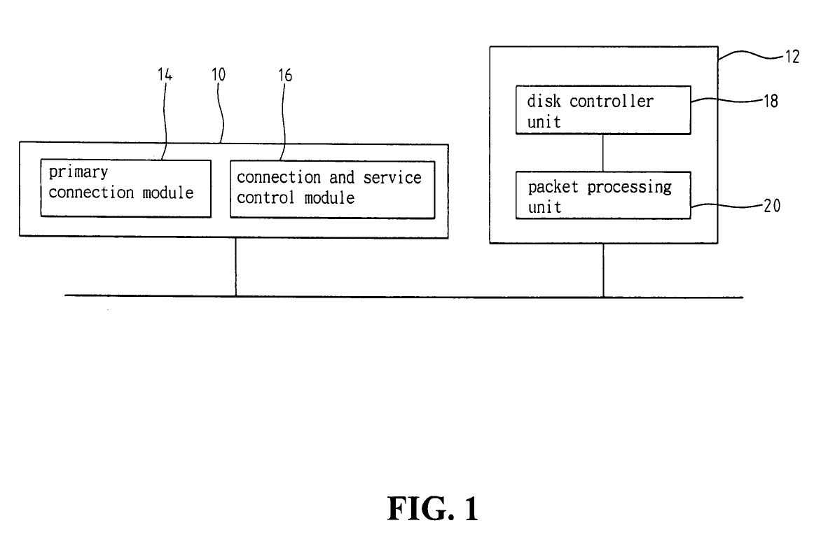

Referring to FIG. 1, the remote control apparatus 10 installable on a host computer is configured with a primary connection module 14 and a connection and service control module 16. The remote control apparatus 10 enables a network administrator to execute certain pre-boot services on each network computer 12 in the local area network environment.

Conventionally, if the network computer 12 is not booted up, the host computer cannot establish network communication with the network computer 12, as the network connection through TCP/IP interface has to go through an IP address. TCP/IP is a suite of networking protocols used for communication across the Internet.

In accordance with the present invention, the host computer having the remote control apparatus 10 is able to select one media access control (MAC) address representing a network computer to directly connect to that computer in a network, and thereafter a virtual IP address is assigned for the network computer for packets to be routed to the network computer through the Internet.

MAC address is a hard-coded interface identification used by the interface hardware for forwarding of packets between computers on a network. A MAC address is a unique number assigned to a network interface card (NIC). This address is created by the manufacturer with a 12-digit number. Each digit is a number from 0-9 or a letter from A-F, for examples, 09:01:27:A9:B3:EW.

A virtual IP address is an IP address bound to a virtual interface which provides current access to the computer through a network router. The virtual IP address identifies a computer in a network that does not necessarily match any of the real networks.

As a pre-condition to using the remote control apparatus 10, the MAC addresses of all computers in the local area network have to be collected and entered into a look-up table (MAC address table), and the MAC address table in the remote control apparatus 10 is accessible to the network administrator. The network administrator only then can pick one MAC address from the MAC address table to directly connect to the associated computer 12 on the same network.

After the initial connection, the MAC address is mapped to a virtual IP address, and a packet carrying the virtual IP address is received by the packet processing unit 20 of the network computer 12, and that information is temporarily held in a data register (not shown) for use in the second stage connection.

The host computer through the remote control apparatus 10 is able to establish connection with the network computer 12 in the pre-boot execution environment in two stages. In the initial stage, the primary connection module 14 establishes direct connection to the associated computer using the MAC address, and a virtual IP address is assigned for the network computer. In the second stage, the connection and service control module 16 takes over the network connection using TCP/IP interface. The packets are routed through the Internet to the virtual IP address of the network computer. Thereafter, certain pre-boot services such as network OS deployment, virus scanning, and BIOS update can be performed on the network computer in the pre-boot execution environment.

Each network computer 12 shall be equipped with a disk controller unit 18 and a packet processing unit 20 as shown in FIG. 1.

The basic functions of the disk controller unit 18 include pre-fomatting the hard disk on the computer, granting protection status to each system sector, and deploying network OS data to the working partition in the configuration mode.

In order to perform the pre-boot services, the host computer needs to have access to the hard disk (not shown) of the network computer 12 through the disk controller unit 18 while ensuring maximum protection for the system data. Though the disk management techniques are previously known, the whole process is illustrated for the purpose of gaining further understanding on the present invention.

In the pre-formatting, the disk controller unit 18 is to divide the bootable disk on the network computer 12 into a working partition with multiple system sectors and a back-up partition to allow network OS data to be loaded into corresponding system sectors and a copy of the OS data to be saved in the back-up partition for later use in system restoration. In the configuration process, protection status is granted to each system sector.

The protection status is the result of an encryption process or reconstructable process, or a combination of the above two, where the reconstructable process can be a backup process or a restoration process.

Further, the functions of the disk controller unit 18 also include duplicating the OS data to the back-up partition and restoring the copy of OS stored in the back-up partition to the working partition, all performed in the configuration mode.

Accordingly, after the connection and service control module 16 of the remote control apparatus 10 takes over the network connection through TCP/IP interface and using the virtual IP address, the network administrator is able to manipulate the hard disk on the network computer 12 to perform certain pre-boot services.

The pre-boot services include dividing the hard disk of the network computer 12 into a working partition having multiple system sectors and a back-up partition, granting protection status to each system sector, deploying network OS data to the working partition in the configuration mode, duplicating OS data to the back-up partition, and restoring the OS copy stored in the back-up partition to the working partition, wherein all these pre-boot services are performed in the configuration mode with maximum protection.

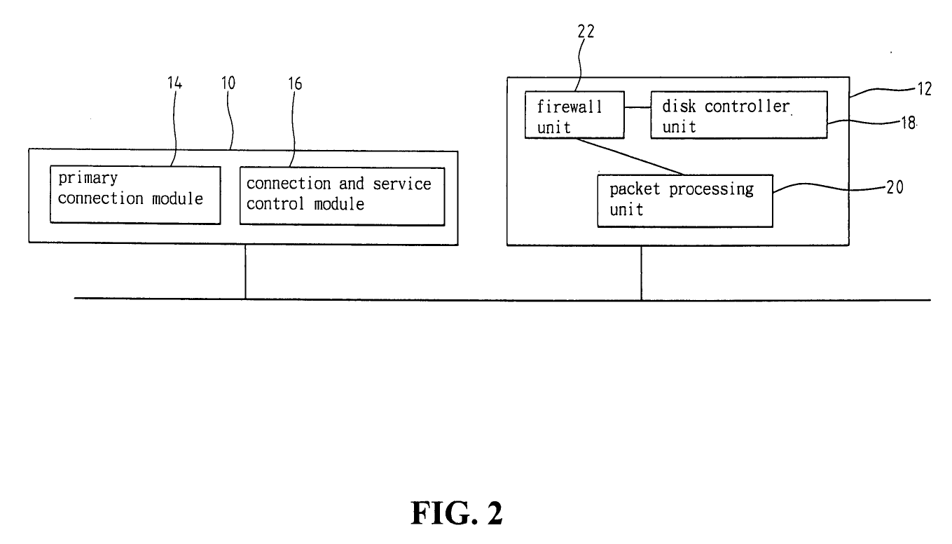

A second embodiment of the invention as shown in FIG. 2, in which a firewall unit 22 is added to the computer configuration besides the disk controller unit 18 and packet processing unit 20.

The basic functions of the firewall unit 22 include authenticating the privilege level of the disk controller unit in the computer, scanning for viruses over incoming packets, and blocking unsafe packets from entering the computer.

Using the remote control apparatus 10, the network administrators can perform time-intensive chores such as initial system configuration, software updates, software configuration, and repairing computers on a remote basis. This can help IT managers simplify the management of increasing number of nodes in the local area network, which could dramatically lower the total IT cost for large companies.

Although the present invention has been described with reference to the preferred embodiments thereof, it is within the scope of the invention to make such variations and modifications as would be apparent to a person having ordinary skill in this field, noting however that the present invention is not limited to personal computers but may be equally applied to notebooks and thin-client workstations. However, the primary utility to which the invention is directed is in the computer-networking field.

What is claimed is:

1. A remote control apparatus installable on a host computer to perform certain pre-boot services on a network computer through remote control, comprising:
a primary connection module to directly connect to a network computer basing on the MAC address of the network computer selected from a MAC address table, and thereafter a virtual IP address is assigned for the network computer; and
a connection and service control module, which takes over the network connection using TCP/IP interface to allow packets to be routed to the virtual IP address, whereby certain pre-boot services can be performed on the network computer on a remote basis.

2. The remote control apparatus as claimed in claim 1, wherein each network computer is provided with a packet processing unit to enable the network computer to retrieve the virtual IP address from a register and to establish network connection through TCP/IP interface when the network computer is in boot stage.

3. The remote control apparatus as claimed in claim 1, wherein each network computer is provided with a disk controller unit, responsible for dividing hard disk on the computer into a working partition having multiple system sectors and a back-up partition, granting protection status granted to each system sector, loading network OS into corresponding system sectors of the working partition in the configuration mode.

4. The remote control apparatus as claimed in claim 3, wherein the protection status is the result of an encryption process.

5. The remote control apparatus as claimed in claim 3, wherein the protection status is the result of a reconstruct able process.

6. The remote control apparatus as claimed in claim 3, wherein the protection status is the combined result of an encryption process and a reconstructable process.

7. The remote control apparatus as claimed in claim 5, wherein the reconstructable process is refer to back up process and restoration process.

8. The remote control apparatus as claimed in claim 6, wherein the reconstructable process is to refer to back up process and restoration process.

9. The remote control apparatus as claimed in claim 1, wherein the network computer is provided with a disk controller unit, whose functions also include duplicating OS data to the back-up partition in the configuration mode, and restoring the OS using the copy stored in the back-up partition to corresponding sectors in the working partition.

10. The remote control apparatus as claimed in claim 1, wherein the pre-boot services to be performed on each network computer include dividing the hard of the network computer into a working partition having multiple system sectors and a back-up partition, deploying network OS data into corresponding system sectors, duplicating the OS and related data to the back-up partition, and then restoring the OS to corresponding sectors of the working partition.

11. The remote control apparatus as claimed in claim 1, wherein each network computer is to further include a firewall unit, whose functions include authenticating the privilege level of a disk controller unit on a network computer, scanning for viruses over all incoming packets, and blocking unsafe packets from entering the computer.

12. The remote control apparatus as claimed in claim 10, wherein the pre-boot services to be supported by the firewall unit are to further include virus scanning over all incoming packets and blocking unsafe packets from entering the computer.
